(19) United States
(12) Patent Application Publication
(10) Pub. No.: US 2020/0080648 A1
(43) Pub. Date: Mar. 12, 2020

(54) Deformed spherical eccentric valve

(71) Applicant: Wenxue Xie, Yangzhou (CN)

(72) Inventor: Wenxue Xie, Yangzhou (CN)

(21) Appl. No.: 16/553,139

(22) Filed: Aug. 27, 2019

(30) Foreign Application Priority Data
Sep. 8, 2018 (CN) 201811047053.3

(51) Int. Cl. F16K 1/226; F16K 5/20

(52) U.S. Cl. CPC F16K 1/2261; F16K 5/204

(57) ABSTRACT

This utility model relates to a deformed spherical eccentric valve comprised of a valve body, valve stem, and open-close member, wherein the open-close member is positioned inside the valve body; the valve stem is connected to the open-close member; a sealing ring is set on the open-close member; a valve seat is set on the valve body; the valve seat and sealing ring are connected to form a sealing surface, which is curved This utility model has the advantages of simple structure, reduced opening and closing torque, good sealing performance, and prolonged valve service life.

### FIELD OF THE INVENTION

This utility model relates to a valve, in particular to a deformed spherical eccentric valve.

### BACKGROUND OF THE INVENTION

Ball and butterfly valves are the two most widely-used valves in the world. They are simple and easy to operate, and can cut off the pipeline medium. For the ball valve, the open-close member (ball) is driven by the valve stem, and rotates around the axis of the valve. The ball valve can also be used for fluid regulation and control. In the hard seal V-ball valve, a strong shearing force exists between the V-ball core and the metal valve seat overlaying hard alloy. The ball valve is especially suitable for media containing fibers and tiny solid particles, etc. The multi-way ball valve, on the other hand, not only can flexibly control media confluence, diversion and flow direction switching on pipelines, but also close any channel to connect the other two. Valves of this type are installed horizontally in pipelines. Ball valves are divided into pneumatic, electric, and manual ball valves. The butterfly valve, also called flap valve, is a kind of regulating valve with a simple structure, mainly composed of the valve body, valve stem, butterfly plate, and sealing ring. The valve body is cylindrical, with short axial length and a built-in butterfly plate. Existing butterfly plates and ball valves have serious abrasion, large bearing pressure, poor sealing performance, large opening and closing torque, and short service life.

### CONTENTS OF THE UTILITY MODEL

This utility model aims to solve the above defects by providing a deformed spherical eccentric valve with simple structure, reduced opening and closing torque, good sealing performance, and long service life.

The technical solution adopted by this utility model is as follows.

The solution is comprised of a valve body, valve stem, and open-close member, wherein said open-close member is positioned inside the valve body; the valve stem is connected to the open-close member; the open-close member is equipped with an annular step with a pressure ring on the open-close member; a valve seat is arranged inside the valve body, which is connected to the sealing ring to form a curved sealing surface, whose radial section is circular; and an oblique line formed by the center of the positive circular section forms an included angle α with the center line of the valve flow passage. The plane formed by the oblique line and the center line of the valve flow passage is perpendicular to the axial line of the valve stem, and the axial line of the valve stem is eccentrically arranged with the center line of the valve flow passage. The center of a radial section opposite the valve stem in all radial sections of the sealing surface is also on the center line of the valve flow passage. When the oblique line coincides with the center line of the valve flow passage, the sealing surface is spherical, the sealing ring forms a spherical section, and the sphere center lies on the center line of the valve flow passage.

As a further improvement of the above technical solution, said open-close member can be a butterfly plate.

As a further improvement of the above technical solution, said open-close member can be a sphere.

Virtues of this utility model:

This utility model has the advantage of simple structure. The structure of the utility model resolves the problems of uneven compression at each point of the sealing surface and deformation and leakage caused by uneven stress on the sealing surface at high temperature and low temperature, reducing opening and closing torque with good sealing performance, prolonging the service life of the valve.

### BRIEF INTRODUCTION TO THE DRAWINGS

FIG. 1 is the structural schematic diagram of this utility model.

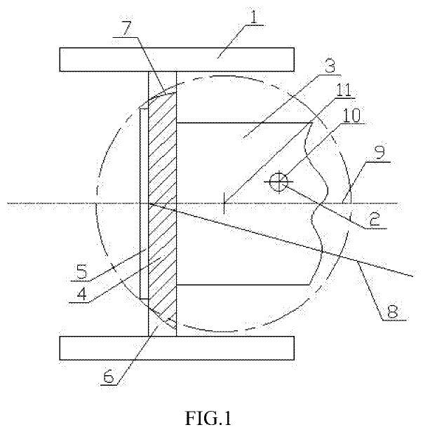

In the FIGURE, 1 is the valve body, 2 is the valve stem, 3 is the open-close member, 4 is the sealing ring, 5 is the pressure ring, 6 is the valve seat, 7 is the sealing surface, 8 is the oblique line, 9 is the center line of the valve flow passage, 10 is the axis line of the valve stem, and 11 is the spherical center.

### DETAILED DESCRIPTION OF PREFERRED EMBODIMENTS

This invention relates to a deformed spherical eccentric valve comprised of a valve body 1, valve stem 2, and open-close member 3, wherein the open-close member 3 is positioned inside the valve body 1; the valve stem 2 is connected to the open-close member 3; one side of the open-close member 3 has an annular step; a sealing ring 4 is set on the annular step; the sealing ring 4 is fixed on the open-close member 3 through an overpressure ring 5; a valve seat 6 is set inside the valve body 1; the valve seat 6 and sealing ring 4 are connected to form a sealing surface 7; and the sealing surface 7 is curved. The radial section of the sealing surface 7 is circular; an oblique line 8 formed by the center of the positive circular section forms an included angle A with the center line of the valve flow passage 9. The plane formed by the oblique line 8 and the center line of the valve flow passage 9 is perpendicular to the axis line of the valve stem 10. The axis line of the valve stem 10 is eccentrically arranged with the center line of the valve flow passage 9. The center of a radial section opposite the valve stem 2 in all radial sections of the sealing surface 7 also lies on the center line of the valve flow passage 9. When the oblique line 8 coincides with the center line of the valve flow passage 9, the sealing surface 7 is spherical, the sealing ring 4 is a part of the sphere, and the center of the sphere 11 lies on the valve flow passage 9.

As a further improvement on the above technical solution, said open-close member can be a butterfly plate.

As a further improvement on the above technical solution, said open-close member can be a sphere.

In all radial sections of the sealing ring surface, the center of the radial section opposite the valve stem—that is, the center of the leftmost end of the sealing ring surface—lies on the center line of the valve flow passage.

It should be emphasized that the above is only one embodiment of the utility model, and does not limit this utility model's patent scope. Equivalent structures or process transformations made by using the specification and attached drawings of this utility model, or directly or indirectly used in other related technical fields, are similarly included in this utility model's patent protection scope.

1. A deformed spherical eccentric valve comprised of a valve body, valve stem, and open-close member, wherein said open-close member is positioned inside the valve body; the valve stem is connected with the open-close member; the open-close member is equipped with an annular step on one side; a sealing ring is affixed with a pressure ring on the open-close member, and arranged on the annular step; a valve seat is set inside the valve body; it and the sealing ring are connected to form a curved sealing surface whose radial section is a positive circular section; an oblique line formed by the center of the positive circular section forms an included angle a with the center line of the valve flow passage. The plane formed by the oblique line and the center line of the valve flow passage is perpendicular to the axial line of the valve stem, and the axial line of the valve stem is eccentrically arranged with the center line of the valve flow passage. The center of a radial section opposite from the valve stem in all radial sections of the sealing surface also lies on the center line of the valve flow passage. When the oblique line coincides with the center line of the valve flow passage, the sealing surface is a spherical surface, the sealing ring forms a part of the sphere, and the sphere center lies on the center line of the valve flow passage.

2. The open-close member of the deformed spherical eccentric valve described in claim 1 is a butterfly plate.

3. The open-close member of the deformed spherical eccentric valve described in claim 1 is a sphere.
